(19) United States
(12) Patent Application Publication
(10) Pub. No.: US 2025/0011204 A1
(43) Pub. Date: Jan. 9, 2025

(54) Method and Composition for the Recirculation Remediation of Contaminants

(71) Applicant: Orin Technologies, LLC, Verona, WI (US)

(72) Inventor: Larry Kinsman, Verona, WI (US)

(21) Appl. No.: 18/764,582

(22) Filed: Jul. 5, 2024

Related U.S. Application Data
(60) Provisional application No. 63/525,024, filed on Jul. 5, 2023.

(51) Int. Cl. C02F 3/00; C02F 3/34; C02F 101/36

(52) U.S. Cl. CPC C02F 3/005; C02F 3/341; C02F 2101/36

(57) ABSTRACT

A method and system for contamination remediation comprising the steps of forming recirculating electrolysis remediation system. The system includes a vessel configured to receive a volume of contaminated fluid and/or soil containing an initial concentration of a perfluoroalkyl and/or polyfluoroalkyl substances (PFAS) and/or a perchloroethylene (PCE) contaminant. The vessel in fluid communication with an electrolysis chamber including electrodes therein. A recirculation pump is configured to recirculate the contaminated fluid, soil, semi-aqueous biosolids and/or sludges between the vessel and the electrolysis chamber. A treatment media comprising biochar is introduced to the vessel and the pump and electrodes are activated resulting in concentrating the contaminant at the surface of the biochar to generate a final concentration of the contaminant in the fluid, soil, semi-aqueous biosolids and/or sludges that is less than the initial concentration.

### CROSS-REFERENCE TO RELATED APPLICATIONS

This application claims priority to U.S. provisional patent application Ser. No. 63/525,024, filed Jul. 5, 2023, the entire contents of which is incorporated herein by reference.

### BACKGROUND OF THE INVENTION

### 1. Technical Field

The present invention relates to a method and composition for remediating contaminants from soil, groundwater, leachates, wastewaters, and surface waters, and more specifically, the present invention describes a method and composition for remediation of contaminants through the administration of a composition including a biochar or other sorbent medias like activated carbon, wherein the biochar and/or activated carbon is combined with electrolysis of contaminants in that water is recirculated through a treatment chamber, either insitu or exsitu.

### 2. Background Art

The discharge of organic compounds and other contaminants into the soil and surface water can lead to contamination of surface and groundwater sources resulting in potential public health impacts. Treatment of such wastewater and the remediation of soils and groundwater contaminated with organic compounds and other contaminants has been expensive, require considerable time, and in many cases are incomplete or unsuccessful.

Many different physical techniques and methods exist for the remediation of soil, groundwater and wastewater to meet the clean-up standards. Examples include dig-and-haul, pump-and-treat, biodegradation, sparging, and vapor extraction. However, meeting stringent clean-up standards is often costly, time-consuming, and often ineffective for many compounds that are recalcitrant, i.e., not responsive to such treatment. Such drawbacks are particularly true of techniques that require contaminated areas to be removed prior to treatments, i.e., ex situ methods, such as is dig-and-haul and pump-and-treat methods. Accordingly, there is a need for an effective method and composition for remediation that treats contaminants in place, i.e., in situ, and/or remediation of contaminated areas that have been removed prior to treatment, i.e., ex situ methods.

Treatment of highly soluble but historically biologically stable organic contaminants such as Perfluoroalkyl/Polyfluoroalkyl Substances (PFAS) have also been shown to be quite difficult with conventional remediation technologies and wastewater treatment. This is particularly true as these compounds are difficult to degrade chemically, thermally, and biologically is all environments. Accordingly, sorbent remediation methods, both in situ and ex situ have become prevalent.

Biochar has been shown to be an effective ex situ treatment for various contaminants such as agricultural runoff containing nitrates, phosphates, and ammonia, mine drainage and tailings containing various heavy metals and low pH, municipal storm water, general heavy metals removal and general organic compounds. Likewise, biochar has been shown to be an effective environmental remediation tool for the remediation of contaminated soil and groundwater, whether by itself, embedded, or in conjunction with other treatments such as, reductive remediation methods (ZVM) (ZVI) and/or carbon sources, oxidative remediation methods, metal stabilization methods or combinations thereof occurring simultaneously or sequentially and the delivery of such systems by injection methods.

However, concerns related to the rerelease of contaminants into the environment from sorbent materials such as activated carbon and biochar and the disposal issues created by regeneration of other sorbent media which result in aqueous streams with extreme concentrations of contaminant dictate the need for effective degradation methods that take advantage of the contaminant concentrating nature of sorbent media, in particular, biochar. While oxidative examples exist, some contaminants are not responsive to such treatments. Biochar offers a unique substrate for biological growth making contaminant targeted biological treatment methods desirable. A remediation system that combined the benefit of this sorbent media with additional remediation techniques is needed for both ex situ and in situ applications.

### SUMMARY OF INVENTION

The inventors have discovered that biochar and other medias, including but not limited to activated carbon, when utilized in a recirculatory electrolysis system for the treatment of contaminated media is a highly effective method for remediation of various organic contaminants. Biochar maintains its sorbative properties removing contaminants from the surrounding media and concentrating them. Additionally, biochar may create a favorable substrate for biological growth promoting biological degradation of contaminants. Furthermore, the inventors have discovered that recirculation of the contaminants during remediation further amplifies the resultant remediation, particularly in the context of PFAS and/or PCE. Such recirculation combined with electrolysis with or without a biochar additive may be applied either to in situ or ex situ treatment applications. Moreover, an addition of the sodium chloride as an additive to the recirculation system results in a significant increase in ClO2 and H2O2 generation, providing the additional benefit of increased electrolysis amperage applied to the system due to the presence of additional salts in solution.

In one embodiment, the present invention provides a method of remediation of an organic contaminant including the steps of: (a) introducing a biochar in dry or slurry form into a treatment area selected from: a subsurface, open pit, pond, or container, defining the contamination volume comprising an organic contaminant; (b) providing a recirculation pump to the contamination volume to provide a recirculated flow path; (c) passing an electrical current between electrodes disposed within the recirculated flow path; and (d) metabolizing the organic contaminant to reduce a volume of the organic contaminant at the contamination zone.

In one embodiment, the present invention provides a method and system for contamination remediation comprising the steps of forming recirculating electrolysis remediation system. The system includes a vessel configured to receive a volume of contaminated fluid and/or soil containing an initial concentration of a perfluoroalkyl and/or polyfluoroalkyl substances (PFAS) and/or a perchloroethylene (PCE) contaminant. The vessel in fluid communication with an electrolysis chamber including electrodes therein, with a fluid flow path over the electrodes. A recirculation pump is configured to recirculate the contaminated fluid and/or soil between the vessel and the electrolysis chamber. In an alternative embodiment, the contaminated fluid may include in whole or in part, semi-aqueous soil mixtures and semi-aqueous biosolid mixtures, such as sludge. A treatment media comprising in part biochar is introduced to the vessel and the pump and electrodes are activated resulting in concentrating the contaminant at the surface of the biochar to generate a final concentration of the contaminant the fluid, soil, semi-aqueous soil mixtures, and/or semi-aqueous biosolid mixture that is less than the initial concentration.

Further aspects or embodiments of the present invention will become apparent from the ensuing description which is given by way of example only.

### BRIEF DESCRIPTION OF THE DRAWINGS

FIG. 1 is box diagram showing a recirculation system according to one embodiment of the present invention; and,

FIG. 2 is box diagram showing a recirculation system according to an alternative embodiment of the present invention

### DETAILED DESCRIPTION

### Bioavailable Absorbent Media

Biochar is a sustainable, pyrolized, recycled cellulosic bio-mass product (>80% fixed carbon) derived from a proprietary blend of recycled organic materials with a high cation exchange, is described above in further detail. Biochar according to the present invention has diverse pore sizes with a minimum total surface area of up to 1,133 square meters per gram or 127 acres/lb.

Biochar has numerous synergistic qualities and is relatively affordable in large quantities for remediation purposes. Biochar has the ability to provide ample usable surface area for maximizing microbial colonization and thereby an active microbial community. Due to its unique ‘honeycomb’ structure, Biochar has the ability to provide increased pore space for the different strains of microbes. And, biochar's affinity for organic and inorganic compounds supports maximum contact (bioavailability through high sorbency) with microbes allowing for complete degradation.

The unique absorption capability of biochar prevents exterior surface microfilm buildup providing long term remediation capabilities. This allows biochar to absorb contaminants for more productive bio-attenuation of contaminants over a longer period of time. Granular Activated Carbon (GAC) primarily adsorbs contamination to the surface of the media, which then is subject to bio-film development, preventing further adsorption. As a result, biochar has been proven to supply long term maintenance free remedial abilities over GAC. Laboratory tests have also shown that biochar has a significantly higher absorptive capacity than commercially available GAC products.

The media, such as but not limited to a sorbent media, according the present invention may be selected from one or more of biochar, GAC, synthetic resin, and combinations thereof.

Results demonstrate significant complete aerobic pathway destruction of chlorinated compounds as to demonstrate that utilizing biochar combined PCE degrading microbes can stop or significantly damage the aerobic pathway of chlorinated compounds. Results demonstrate the system of the present invention to be equally effective on PCBs as well.

### EXAMPLES

### 1. Comparative Example 1—PFAS Electrolysis Without Recirculation

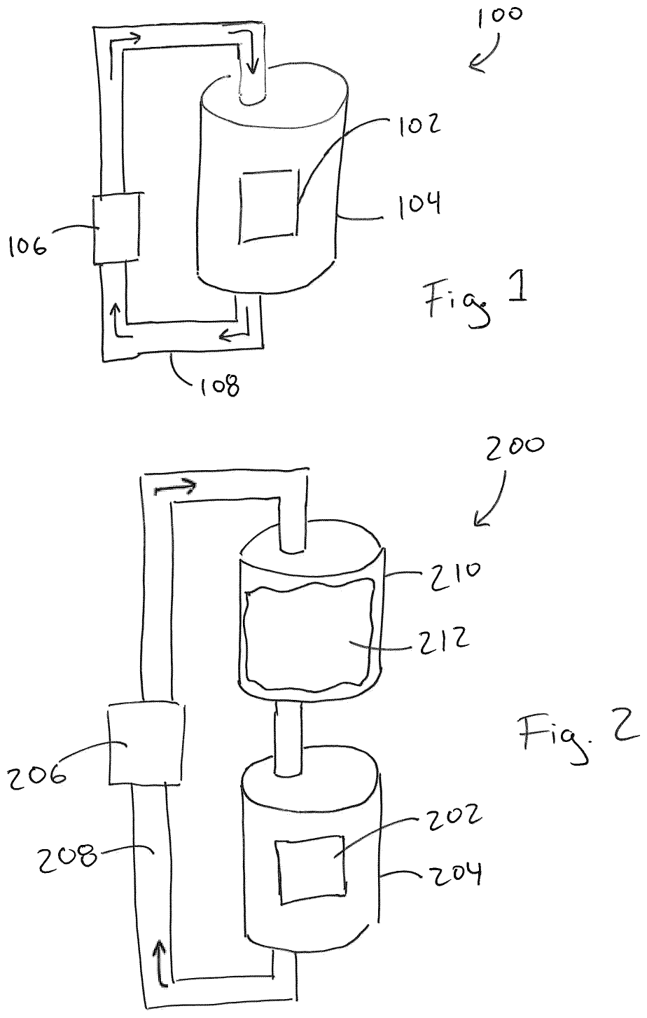

Test methodology, as shown in FIG. 1, included a system 100 including an electrolysis chamber 102 having at least two electrodes supplied with an electrical current submerged in a cauldron 104 containing 30 L of PFAS impacted groundwater, and a pump 106 configured to recirculate the PFAS impacted groundwater through the electrolysis chamber 102 via conduit 108. Alternatively, the cauldron 104 may be any alternative form of a liquid retaining vessel for ex situ applications, or a lagoon, pond or other water retention structure for in situ applications. Parameter readings were taken before the electrodes were turned on, i.e., “baseline” readings, at 30 mins, 1 hour, 8 hours and 24 hours. Water collection occurred at the intervals of initial “baseline”, 1 hour, 8 hours and 24 hours. Baseline sampling showed 149,770 ug/L of total PFAS, there was a decrease of 24.7%, 63.3% and 74% at the 1 hour, 8 hour and 24 hour sampling times. Results showed the electrolysis to be very effective at reducing the long chain PFAS compounds while less effective at breaking down the short chain PFAS compounds. As shown below in Table 1.

TABLE 1
Comparative Example 1 Analyte ng/L Over Time

| | Baseline | | | |
|---|---|---|---|---|
| Analyte ng/L | (0 Hr) | 1 HR | 8 HR | 24 HR |
| PFBA | 1,800.00 | 1,900.00 | 1,700.00 | 1,800.00 |
| PFPeA | 6,500.00 | 7,200.00 | 6,800.00 | 7,100.00 |
| PFHxA | 4,900.00 | 6,300.00 | 5,300.00 | 5,400.00 |
| PFHpA | 1,300.00 | 1,300.00 | 1,100.00 | 1,000.00 |
| PFOA | 1,400.00 | 1,300.00 | 660 | 340 |
| PFNA | 840 | 610 | 130 | 51 |
| PFDA | 200 | 100 | 50 | 50 |
| PFUnA | 200 | 100 | 50 | 50 |
| PFDoA | 200 | 100 | 50 | 50 |
| PFTRDA | 140 | 70 | 35 | 35 |
| PFTEDA | 200 | 100 | 50 | 50 |
| PFBS | 900 | 880 | 800 | 830 |
| PFPeS | 2,300.00 | 2,400.00 | 2,300.00 | 2,300.00 |
| PFHxS | 29,000.00 | 26,000.00 | 20,000.00 | 14,000.00 |
| PFHpS | 2,300.00 | 2,100.00 | 750 | 230 |
| PFOS | 83,000.00 | 49,000.00 | 7,800.00 | 1,700.00 |
| PFNS | 280 | 140 | 70 | 70 |
| PFDS | 280 | 140 | 70 | 70 |
| PFOSA | 200 | 140 | 70 | 70 |
| MeFOSAA | 230 | 140 | 70 | 70 |
| EtFOSAA | 230 | 140 | 70 | 70 |
| 4:2 FTS | 230 | 73 | 43 | 45 |
| 6:2 FTS | 12,000.00 | 12,000.00 | 6,700.00 | 3,300.00 |
| 8:2 FTS | 230 | 150 | 33 | 70 |
| HFPO-DA | 230 | 140 | 70 | 70 |
| DONA | 80 | 40 | 20 | 20 |
| 9Cl-PF3ONS | 200 | 100 | 50 | 50 |
| 11CI-PF3OUdS | 200 | 100 | 50 | 50 |
| TOTAL | 149,770.00 | 112,763.00 | 54,891.00 | 38,941.00 |
| TOF ug/L | 110 | 99 | 44 | 31 |

TABLE 2
Comparative Example 1 Analyte Percentage Decrease Over Time

| | | 1 Hr | 8 Hr | 24 Hr |
|---|---|---|---|---|
| | Baseline | Percent | Percent | Percent |
| Analyte ng/L | (0 Hr) | Change | Change | Change |
| PFBA | 1,800.00 | −5.60% | 5.60% | 0.00% |
| PFPeA | 6,500.00 | −10.80% | −4.60% | −9.20% |
| PFHxA | 4,900.00 | −28.60% | −8.20% | −10.20% |
| PFHpA | 1,300.00 | 0.00% | 15.40% | 23.10% |
| PFOA | 1,400.00 | 7.10% | 52.90% | 75.7% |
| PFNA | 840 | 27.40% | 84.50% | 93.90% |
| PFDA | 200 | 50.00% | 75.00% | 75.00% |
| PFUnA | 200 | 50.00% | 75.00% | 75.00% |
| PFDoA | 200 | 50.00% | 75.00% | 75.00% |
| PFTRDA | 140 | 50.00% | 75.00% | 75.00% |
| PFTEDA | 200 | 50.00% | 75.00% | 75.00% |
| PFBS | 900 | 2.20% | 11.10% | 7.80% |
| PFPeS | 2,300.00 | −4.30% | 0.00% | 0.00% |
| PFHxS | 29,000.00 | 10.30% | 31.00% | 51.70% |
| PFHpS | 2,300.00 | 8.70% | 67.40% | 90.00% |
| PFOS | 83,000.00 | 41.00% | 90.60% | 98.00% |
| PFNS | 280 | 50.00% | 75.00% | 75.00% |
| PFDS | 280 | 50.00% | 75.00% | 75.00% |
| PFOSA | 200 | 30.00% | 65.00% | 65.00% |
| MeFOSAA | 230 | 50.00% | 75.00% | 75.00% |
| EtFOSAA | 230 | 50.00% | 75.00% | 75.00% |
| 4:2 FTS | 230 | 73.90% | 84.60% | 83.90% |
| 6:2 FTS | 12,000.00 | 0.00% | 44.20% | 72.50% |
| 8:2 FTS | 230 | 34.80% | 85.70% | 69.60% |
| HFPO-DA | 230 | 50.00% | 75.00% | 75.00% |
| DONA | 80 | 50.00% | 75.00% | 75.00% |
| 9Cl-PF3ONS | 200 | 50.00% | 75.00% | 75.00% |
| 11CI-PF3OUdS | 200 | 50.00% | 75.00% | 75.00% |
| TOTAL | 149,770.00 | 24.70% | 63.30% | 74.00% |
| TOF ug/L | 110 | 10.00% | 60.00% | 71.80% |

TABLE 3
Comparative Example 1 Methodology

| | | | | | |
|---|---|---|---|---|---|
| Time | Baseline | 30 Min | 1 Hour | 8 Hour | 24 Hour |

Multiparameter Probe

| | | | | | |
|---|---|---|---|---|---|
| pH | 7.41 | 7.59 | 7.51 | 7.09 | 6.82 |
| ORP | 155.5 | 64.3 | −172.7 | 709 | 752.4 |
| % DO | 62.3 | 60.6 | 77.3 | 110 | 148.2 |
| ppm DO | 5.2 | 5.18 | 6.39 | 8.39 | 13.22 |
| uS/cm | 665 | 666 | 648 | 537 | 382 |
| uS/cmA | 621 | 623 | 621 | 564 | 344 |
| MO cm | | | | | |
| ppm TDS | 332 | 333 | 324 | 269 | 191 |
| PSU | | | | | |
| Temp C. | 21.55 | 21.55 | 22.78 | 27.61 | 19.76 |

Ampoules/Strips

| | | | | | |
|---|---|---|---|---|---|
| DO (ppm) | 6.0 | | 12.0 | 12+ | 12+ |
| Chlorine | | — | — | — | — |
| C102 Strip (ppm) | 0.0 | — | 0 to 10 | 10.0 | 10 to 25 |
| Peroxide Strip (ppm) | 0.0 | — | 3.0 | 10.0 | 10 to 25 |

Electrical Properties

| | |
|---|---|
| Voltage (V) | 24 |
| Amperage (amps) | 2.1 |

### 2. Inventive Example 2—PFAS Electrolysis with Recirculation

For this a new cauldron was used containing 33 L of PFAS impacted groundwater from the same site as in comparative example test no. 1. The cauldron is set up with a recirculation pump to prevent the water from stagnating in and around the electrodes. Doing so allows the electrodes to potentially contact more PFAS. Baseline sampling showed 97,390 ng/L of total PFAS, there was a decrease of 24.0%, 38% and 58% at the 1 hour, 8 hour and 24 hour sampling times. Results showed significant breakdown of longer chain PFAS compounds but it was less effective on the shorter chains. Overall the results of the first trial appear to have demonstrated greater success in the breakdown of both long and short chain PFAS as compared to the comparative example lacking recirculation, as demonstrated by the test results below.

TABLE 4
Inventive Example 2 Analyte ng/L Over Time

| | Baseline | | | |
|---|---|---|---|---|
| Analyte ng/L | (0 Hr) | 1 HR | 8 HR | 24 HR |
| PFBA | 980 | 960 | 930 | 790 |
| PFBS | 680 | 630 | 600 | 510 |
| PFPeA | 3900 | 3300 | 3200 | 2600 |
| PFPeS | 2000 | 1800 | 1600 | 1300 |
| PFHxA | 3400 | 3800 | 3400 | 2700 |
| 4:2 FTS | 0 | 22 | 21 | 19 |
| PFHxS | 20000 | 18000 | 16000 | 15000 |
| PFHpA | 1100 | 890 | 900 | 860 |
| PFHpS | 1200 | 1400 | 1100 | 650 |
| PFOA | 1300 | 1200 | 1100 | 950 |
| PFOS | 51000 | 33000 | 22000 | 9800 |
| PFOSA | 70 | 32 | 23 | 19 |
| 6:2 FTS | 11000 | 8200 | 8700 | 5800 |
| PFNA | 480 | 390 | 270 | 120 |
| PFDA | 0 | 5.2 | 0 | 0 |
| 8:2 FTS | 280 | 200 | 86 | 36 |
| Totals | 97390 | 73829.2 | 59930 | 41154 |
| Perchlorate ug/L | 0 | 0 | 0.4 | 1 |
| TOF-CIC ug/L | 69 | 68 | 56 | 43 |

TABLE 5
Inventive Example 2 Analyte Percentage Decrease Over Time

| | | 1 Hr | 8 Hr | 24 Hr |
|---|---|---|---|---|
| | Baseline | Percent | Percent | Percent |
| Analyte ng/L | (0 Hr) | Change | Change | Change |
| PFBA | 980 | 2% | 5% | 19% |
| PFBS | 680 | 7% | 12% | 25% |
| PFPeA | 3900 | 15% | 18% | 33% |
| PFPeS | 2000 | 10% | 20% | 35% |
| PFHxA | 3400 | −12% | 0% | 21% |
| 4:2 FTS | 0 | 0% | 5% | 14% |
| PFHxS | 20000 | 10% | 20% | 25% |
| PFHpA | 1100 | 19% | 18% | 22% |
| PFHpS | 1200 | −17% | 8% | 46% |
| PFOA | 1300 | 8% | 15% | 27% |
| PFOS | 51000 | 35% | 57% | 81% |
| PFOSA | 70 | 54% | 67% | 73% |
| 6:2 FTS | 11000 | 25% | 21% | 47% |
| PFNA | 480 | 19% | 44% | 75% |
| PFDA | 0 | 0% | 100% | 100% |
| 8:2 FTS | 280 | 29% | 69% | 87% |
| Totals | 97390 | 24% | 38% | 58% |
| TOF-CIC ug/L | 69 | 1% | 19% | 38% |

TABLE 6
Inventive Example 1 Methodology

| | | | | | |
|---|---|---|---|---|---|
| Time | Baseline | 30 Min | 1 Hour | 8 Hour | 24 Hour |

Multiparameter Probe

| | | | | | |
|---|---|---|---|---|---|
| mVpH | −47.7 | −49.7 | −55.6 | −39.8 | −21.6 |
| pH | 7.58 | 7.6 | 7.7 | 7.43 | 7.12 |
| ORP | 42.3 | −148.6 | −214.1 | −159.8 | 644.6 |
| % DO | 73.3 | 99.2 | 116.1 | 151.5 | 171.2 |
| ppm DO | 6.85 | 9.19 | 10.73 | 13.7 | 15.95 |
| uS/cm | 742 | 728 | 722 | 620 | 457 |
| uS/cmA | 618 | 612 | 609 | 536 | 384 |
| MO cm | 0.0013 | 0.0014 | 0.0014 | 0.0016 | 0.0022 |
| ppm TDS | 371 | 364 | 360 | 310 | 228 |
| PSU | 0.37 | 0.36 | 0.35 | 0.3 | 0.22 |
| Temp C. | 16.17 | 16.62 | 16.79 | 17.85 | 16.56 |

Ampoules/Strips

| | | | | | |
|---|---|---|---|---|---|
| DO (ppm) | 8 | 9 | 10.5 | 12+ | 12+ |
| Chlorine | | | | | |
| CI02 Strip | 0 | 0 | 0 to 5 | 10 to 25 | 25 |
| (ppm) | | | | | |
| Peroxide | 0 | 0 | 0 to 1 | 10 | 10 to 15 |
| Strip (ppm) | | | | | |

Electrical Properties

| | | | | | |
|---|---|---|---|---|---|
| Voltage (V) | 24.1 | 24.1 | 24.1 | 24.1 | 24.1 |
| Amperage | 2.18 | 2.34 | 2.25 | 1.85 | 1.27 |
| (amps) | | | | | |

### 3. Inventive Example 3—PFAS Electrolysis with Biochar and Recirculation

This trial test used the same cauldron with recirculation and electrodes as in test 2. The change for this trial is the addition of biochar at a loading rate of 0.5% of the sample by weight. Adding the small amount of biochar to the 33 L of water significantly reduced the concentrations of PFAS compounds almost by 98% after only the first hour going from 113,423 ng/L down to 2,531.4 ng/L. Although by the end it had reached a plateau getting it down to 609 ng/L after 24 hours. All of the longer chain compounds were entirely eliminated while the three smallest chain compounds showed higher concentrations at 24 hours than they did after the 1 hour sampling event, as shown in the following tables.

TABLE 7
Inventive Example 3 Analyte ng/L Over Time

| | | 1 Hr | 8 Hr | 24 Hr |
|---|---|---|---|---|
| | Baseline | Percent | Percent | Percent |
| Analyte ng/L | (0 Hr) | Change | Change | Change |
| PFBA | 930 | 200 | 200 | 250 |
| PFBS | 630 | 7 | 8.5 | 59 |
| PFPeA | 3500 | 78 | 110 | 150 |
| PFPeS | 1900 | 30 | 37 | 0 |
| PFHxA | 3600 | 41 | 53 | 0 |
| 4:2 FTS | 16 | 0 | 0 | 0 |
| PFHpS | 26000 | 480 | 720 | 0 |
| PFHpA | 1100 | 17 | 23 | 0 |
| PFHpS | 1400 | 20 | 36 | 0 |
| PFOA | 1200 | 19 | 32 | 150 |
| PFOS | 63000 | 1400 | 2600 | 0 |
| PFOSA | 65 | 2.1 | 3.4 | 0 |
| 6:2 FTS | 9300 | 220 | 370 | 0 |
| PFNA | 590 | 13 | 22 | 0 |
| PFDA | 12 | 0 | 0 | 0 |
| 8:2 FTS | 180 | 4.3 | 8 | 0 |
| Totals | 113423 | 2531.4 | 4222.9 | 609 |
| Perchlorate ug/L | 0 | 0 | 0.43 | 1.3 |
| TOF-CIC ug/L | 78 | 1.2 | 2.3 | 2.2 |

TABLE 8
Inventive Example 3 Analyte Percentage Decrease Over Time

| | | 1 Hr | 8 Hr | 24 Hr |
|---|---|---|---|---|
| | Baseline | Percent | Percent | Percent |
| Analyte ng/L | (0 Hr) | Change | Change | Change |
| PFBA | 930 | 78% | 78% | 73% |
| PFBS | 630 | 99% | 99% | 91% |
| PFPeA | 3500 | 98% | 97% | 96% |
| PFPeS | 1900 | 98% | 98% | 100% |
| PFHxA | 3600 | 99% | 99% | 100% |
| 4:2 FTS | 16 | 100% | 100% | 100% |
| PFHpS | 26000 | 98% | 97% | 100% |
| PFHpA | 1100 | 98% | 98% | 100% |
| PFHpS | 1400 | 99% | 97% | 100% |
| PFOA | 1200 | 98% | 97% | 88% |
| PFOS | 63000 | 98% | 96% | 100% |
| PFOSA | 65 | 97% | 95% | 100% |
| 6:2 FTS | 9300 | 98% | 96% | 100% |
| PFNA | 590 | 98% | 96% | 100% |
| PFDA | 12 | 100% | 100% | 100% |
| 8:2 FTS | 180 | 98% | 96% | 100% |
| Totals | 113423 | 98% | 96% | 99% |
| TOF-CIC ug/L | 78 | 98% | 97% | 97% |

TABLE 9
Inventive Example 3 Test Conditions

| Time | | | | | | |
|---|---|---|---|---|---|---|
| | Post | 30 | 1 | 8 | 23 | 24 |
| Baseline | Dosing | Min | Hour | Hour | Hour | Hour |

Multiparameter Probe

| | | | | | | | |
|---|---|---|---|---|---|---|---|
| mVpH | −45.1 | −37.9 | −41.3 | −43 | −40.5 | −47 | −41.7 |
| pH | 7.35 | 7.26 | 7.32 | 7.35 | 7.3 | 7.41 | 7.32 |
| ORP | 57.5 | 55 | −115 | −172 | −207.9 | −234.7 | −245.1 |
| % DO | 72 | 71.1 | 91.8 | 112.7 | 139.2 | 150.1 | 154.1 |
| ppm DO | 6.68 | 6.6 | 8.44 | 10.44 | 12.73 | 13.95 | 14.26 |
| uS/cm | 699 | 718 | 717 | 716 | 649 | 539 | 532 |
| uS/emA | 590 | 605 | 611 | 605 | 556 | 456 | 452 |
| MO cm | 0.0014 | 0.0014 | 0.0014 | 0.0014 | 0.0015 | 0.0019 | 0.0019 |
| ppm TDS | 349 | 359 | 359 | 358 | 325 | 269 | 266 |
| PSU | 0.34 | 0.35 | 0.35 | 0.35 | 0.32 | 0.26 | 0.26 |
| Temp. C. | 16.79 | 16.71 | 17.19 | 17.37 | 17.37 | 16.94 | 17.08 |

Ampoules/Strips

| | | | | | | | |
|---|---|---|---|---|---|---|---|
| DO (ppm) | 6 | — | 8 | 10 | 12+ | 12+ | 12+ |
| Chlorine | — | — | — | — | — | — | — |
| CIO2 Strip | 0 | — | 0 | 0 | 0 | 0 | 0 |
| (ppm) | | | | | | | |
| Peroxide | 0 | — | 0 | 0 | 0 | 0 | 0 |
| Strip (ppm) | | | | | | | |

Electrical Properties

| | | | | | | |
|---|---|---|---|---|---|---|
| Voltage (V) | 24.1 | 24.1 | 24.1 | 24.1 | 24.1 | 24.1 |
| Amperage | 2.12 | 2.22 | 2.19 | 2.03 | 1.6 | 1.58 |
| (amps) | | | | | | |

### 4. Inventive Example 4—PFAS Electrolysis with Sodium Chloride and Recirculation

This trial test used the same cauldron with recirculation and electrodes as in test 2 and 3. The change for this trial is the addition of sodium chloride at a loading rate of 12 g in the 33 L of PFAS impacted groundwater. The addition of the sodium chloride showed significant spikes in ClO2 and H2O2 through the 24 hour run time. Due to the additional salts, the present inventors were also able to apply approximately two times the amps through the same configuration. Baseline sampling showed 116,390 ng/L of total PFAS, there was a decrease of 28%, 67% and 72% at the 1 hour, 8 hour and 24 hour-2 sampling times respectively, as shown in the tables below.

TABLE 10
Inventive Example 4 Analyte ng/L Over Time

| Analyte | Baseline | | | | |
|---|---|---|---|---|---|
| ng/L | (0 Hr) | 1 Hr | 8 Hr | 24 Hr | 24 Hr-2 |
| PFBA | 1000 | 990 | 990 | 250 | 1000 |
| PFBS | 610 | 680 | 660 | 1200 | 830 |
| PFPeA | 3500 | 3700 | 3600 | 4400 | 3700 |
| PFPeS | 1800 | 2000 | 1800 | 6700 | 2200 |
| PFHxA | 3600 | 4900 | 3900 | 4900 | 4400 |
| 4:2 FTS | 0 | 0 | 18 | 23 | 21 |
| PFHxS | 26000 | 27000 | 18000 | 17000 | 15000 |
| PFHpA | 1100 | 1200 | 1100 | 1000 | 950 |
| PFHpS | 950 | 790 | 450 | 200 | 340 |
| PFOA | 1100 | 1000 | 720 | 440 | 500 |
| PFOS | 66000 | 32000 | 0 | 1400 | 1400 |
| PFOSA | 0 | 0 | 24 | 8.2 | 13 |
| 6:2 FTS | 10000 | 9400 | 6700 | 2900 | 2500 |
| PFNA | 550 | 370 | 130 | 31 | 30 |
| PFOA | 0 | 0 | 0 | 0.97 | 0.87 |
| 8:2 FTS | 180 | 0 | 22 | 6.2 | 8.5 |
| Totals | 116390 | 84030 | 38114 | 40459.37 | 32893.37 |
| Perchlorate | 0 | 0.34 | 3.4 | 17 | |
| ug/L | | | | | |
| TOF-CIC | 97 | 67 | 40 | 28 | |
| ug/L | | | | | |

TABLE 11
Inventive Example 4 Analyte Percentage Decrease Over Time

| | | 1 Hr | 8 Hr | 24 Hr | 24 Hr-2 |
|---|---|---|---|---|---|
| | Baseline | Percent | Percent | Percent | Percent |
| Analyte ug/L | (0 Hr) | Change | Change | Change | Change |
| PFBA | 1000 | 1% | 1% | 75% | 0% |
| PFBS | 610 | −11% | −8% | −97% | −36% |
| PFPeA | 3500 | −6% | −3% | −26% | −6% |
| PFPeS | laco | −11% | 0% | −272% | −22% |
| PFH xA | 3600 | −36% | −8% | −36% | −22% |
| 4:2 FTS | 0 | | | | |
| PFH xS | 26000 | −4% | 31% | 35% | 42% |
| PFH pA | 1100 | −9% | 0% | 9% | 14% |
| PFHpS | 950 | 17% | 53% | 79% | 64% |
| PFOA | 1100 | 9% | 35% | 60% | 55% |
| PFOS | 66060 | 52% | 100% | 98% | 98% |
| PFOSA | 0 | | | | |
| 6:2 FTS | 10000 | 6% | 33% | 71% | 75% |
| PFNA | 550 | 33% | 76% | 94% | 95% |
| PFOA | 0 | | | | |
| 8:2 FTS | 180 | 100% | 88% | 97% | 95% |
| Totals | 116390 | 28% | 67% | 65% | 72% |
| TOF-CIC ug/L | 97 | 31% | 59% | 71% | |

TABLE 12
Inventive Example 4 Test Conditions & parameters

| Time | | | | | | |
|---|---|---|---|---|---|---|
| | Post | 30 | 1 | 8 | 23 | 24 |
| Baseline | Dosing | Min | Hour | Hour | Hour | Hour |

Multiparameter Probe

| | | | | | | | |
|---|---|---|---|---|---|---|---|
| mVpH | −44 | −41.4 | −45 | −50.9 | −70.9 | −75.2 | −70.7 |
| pH | 7.36 | 7.32 | 7.38 | 7.48 | 7.81 | 7.89 | 7.81 |
| ORP | 60.5 | 63.9 | −122.4 | 175 | 711.4 | 724.7 | 630.6 |
| % DO | 77.3 | 76.2 | 96.1 | 112.5 | 141.5 | 152.5 | 159.3 |
| ppm DO | 7.1 | 6.97 | 8.8 | 10.33 | 12.62 | 13.75 | 14.31 |
| uS/cm | 699 | 1390 | 1420 | 1405 | 1248 | 1049 | 1026 |
| uS/LitiA | 592 | 1180 | 1200 | 1180 | 1088 | 918 | 899 |
| MO cm | 0.0014 | C.0007 | 0.0007 | 0.0007 | 0.0008 | 0.001 | 0 001 |
| ppm IDS | 349 | 695 | 710 | 702 | 623 | 524 | 513 |
| PSU | 0.34 | 0.7 | 0.72 | 0.71 | 0.63 | 0.52 | 0.51 |
| Temp. C. | 17 | 17.01 | 16.79 | 16.58 | 18.21 | 18.45 | 18.5 |

Ampoule/Strips

| | | | | | | | |
|---|---|---|---|---|---|---|---|
| DO (ppm) | 7 | 7 | 10 | 11 | 10 | 8 | 3 |
| Chlorine | | | | | | | |
| C102 | 0 | 0 | 10 to 25 | 25 | 250 to 500 | 500 | 5)0.0 |
| Strip (pprr) | | | | | | | |
| Peroxide Strip | 0 | 0 | 10 | 10 | 100− | 100+ | 100+ |
| (ppm) | | | | | | | |
| H202 amp (pprr) | | | S.0 | 7.5 | 15 | 15 | 15 |
| Peroxide | | | | | <50 | <50 | <50 |

Electrical Properties

| | | | | | | |
|---|---|---|---|---|---|---|
| Voltage (V) | 24.1 | 24.1 | 24.1 | 24.1 | 24.1 | 24.1 |
| Amperage (amps) | 4.08 | 4.25 | 4.24 | 3.45 | 3.06 | 3.03 |

### 5. Inventive Example 5—PFAS Electrolysis with Sodium Chloride and Recirculation

In Inventive Example 5, Applicant understands that leachate from a foam fractionation system is impacted with concentrated PFAS. The goal of the bench scale treatability testing was to determine the most efficient and effective option to treat PFAS. Applicant utilized a specialized bench-scale electrokinetic recirculation system, such as that depicted in FIG. 1 along with Biochar to treat PFAS impacted leachate over a period of 48 hours. Leachate parameters were tracked throughout the duration of the study.

Methodology—Applicant's approach utilized a bench-scale electrokinetic recirculation system designed to treat bulk leachate. Applicant added four gallons of homogenized leachate into the stainless-steel reactor vessel. Once the leachate was in the vessel, an untreated control sample was collected via an Alexis Variable Speed Peristaltic Pump with HDPE tubing. Samples were taken approximately 4 inches below the surface of the impacted media. Following the initial baseline sample collection, the recirculation system was turned on. The recirculation rate is approximately 1 gallon per minute. Approximately two pounds of biochar were added to the vessel and after 20 minutes of biochar recirculating in the vessel, another sample was collected. After the 20-minute sample collection, the electrokinetic system was activated. Periodic sampling occurred at 1, 8, 24, 36, and 48 hours after the electrokinetic system was activated. Leachate parameter data was collected using a Hanna HI98194 multiparameter probe. Applicant recorded the leachate parameters at various times throughout the 48 hours of the study. Parameters consisted of pH, ORP (mV), Dissolved Oxygen “DO” (ppm), Conductivity (mS/cm), Resistivity (Ωcm), Salinity “PSU” (ppm), and Temperature (° C.). Periodically, upon visible inspection, the electrode cell was pressure washed to remove calcium carbonate and other precipitate build up.

Results—Applicant's primary parameters are provided in the order of pH, ORP (mv), DO (ppm), and Temperature (° C.). The baseline readings were 7.12, 47.1 mV, 0.1 ppm, 20.23° C., respectively. Throughout the study Applicant observed the pH decrease significantly to acidic conditions. The 48-hour reading measured pH at 3.06. The ORP increased to 911.7 mV within the first 24 hours and then tapered off to slightly above the baseline levels. Dissolved Oxygen increased from anoxic levels up to 9.22 ppm by the 48-hour sample collection. This is to be expected due to the production of oxygen from water around the electrode. Temperature ranged from 13.78° C. to 27.83° C. throughout the study. The electrokinetic system generates heat, so to reduce the rise in temperature, Applicant used a stainless-steel coil set in ice to cool the recirculating flow water. As the leachate recirculates, the fluid runs through the cooling coil and back into the main vessel maintaining a safe and operable temperature. The full parameter data is located in Table 15.

Laboratory analysis was performed by Eurofins Cedar Falls using EPA Method 1633.The sum of all measured PFAS in the control sample was 937,230 ng/L. The two most prevalent compounds in the control sample were 5:3 FTCA and PFOA at 410,000 and 240,000 ng/L, respectively. Another noteworthy compound, PFOS, measured 32,000 ng/L.

After the addition of biochar to the vessel and recirculating the material for 20 minutes, a 65.9% reduction in the sum of PFAS was observed. 5:3 FTCA was reduced to 100,000 ng/L. PFOA was reduced to 110,000 ng/L. One hour after the electrokinetic system was activated, 5:3 FTCA measured 1,300 ng/L and PFOA measured 2,000 ng/L. The sum of all PFAS measured 5,074 ng/L resulting in a 99.5% reduction from the control sample. Interestingly, the eight-hour sample measured the sum of all PFAS at 55,499 ng/L. 5:3 FTCA and PFOA contributed the most substantial increases from the one-hour sample measuring 17,000 and 18,000 ng/L, respectively. The 48-hour sample measured a 98.4% reduction in the sum of all PFAS with 5:3 FTCA below the detection limit and PFOA at 3,600 ng/L. PFOS had an initial concentration of 32,000 ng/L and by the 48-hour sample, the concentration was 170 ng/L. The full analytical data is found in Tables 13 and 14.

Approximately three hours after the electrokinetic system was activated, foaming was prominent on the surface of the leachate in the vessel. Applicant added approximately 15 grams of a defoaming agent to prevent foam from spreading out of the vessel. Applicant believes the foam suppression prior to the eight-hour sample is the reason for significantly higher PFAS concentrations compared to the one-hour sample. Degradation of the PFAS foam formation may have re-added PFAS into the water column. Applicant suspects that a true 1-hour result would be a midpoint between the baseline and 8-hour samples. Foam formation was monitored and controlled for the subsequent samples. Continued degradation is observed in the 24 & 36-hour samples, however the 48-hour sample shows an increase in concentrations.

As noted in the results section, the 48-hour sample pH was 3.06. Because of the low pH, Applicant collected a duplicate 48-hour sample and attempted to increase the pH by adding a pH buffer. Approximately 29 grams of the pH buffer was added incrementally to the sample until the pH was neutral. PFAS concentrations from the 48-hour pH buffered sample are more consistent with the 36-hour concentration, but still slightly higher than the 36-hour concentration.

Overall, each sample collected following the activation of the electrokinetic system achieved greater than 94% reduction in the sum of all PFAS compounds compared to the control sample. PFOA & PFOS are greater than 98% reduced compared to the control sample. Results strongly indicate that with additional biochar, PFAS compounds would approach non-detect levels across the board.

TABLE 13
Inventive Example 5 Analyte ng/L Over Time

| | | | | | | | 48- | 48- |
|---|---|---|---|---|---|---|---|---|
| | | | | | | | hour | hour |
| Analyte | control | Biochar | 1- | 8- | 24- | 36- | No pH | with pH |
| (ng/L) | (0 Hrs) | 20 Mins | hour | hour | hour | hour | Buffer | Buffer |
| 3:3 FTCA | 1,000 | | | | | | | |
| 5:3 FTCA | 410,000 | 100,000 | 1,300 | 17,000 | 4,100 | | | 930 |
| 7:3 FTCA | 15,000 | | | 800 | | | | |
| 6:2 FTS | 24,000 | 8,500 | | 1,500 | 980 | 91 | 250 | |
| NEtFOSAA | 430 | | | 49 | | | | |
| NMeFOSAA | 1,700 | 730 | | 180 | | | | |
| PFBS | 11,000 | 3,400 | 65 | 600 | 920 | 310 | 760 | 290 |
| PFBA | 3,000 | 1,800 | 260 | 590 | 900 | 1,100 | 1,500 | 1,700 |
| PFDA | 490 | | | 42 | | | | |
| PFDS | | | | 23 | | | | |
| PFHpS | 1,100 | 420 | | 54 | 34 | | | |
| PFHpA | 54,000 | 23,000 | | 4,000 | 5,100 | 1,000 | 2,200 | 720 |
| PFHxA | 52,000 | 22,000 | 640 | 5,100 | 5,900 | 2,300 | 4,600 | 2,100 |
| PFNA | 3,900 | 1,600 | | 320 | 99 | | 30 | |
| FOSA | 610 | | | 71 | | | | |
| PFOS | 32,000 | 15,000 | 240 | 2,500 | 760 | 100 | 170 | 180 |
| PFPeS | 2,100 | 880 | | 130 | 180 | 33 | 80 | 33 |
| PFPeA | 2,900 | 1,300 | 89 | 540 | 760 | 600 | 970 | 680 |
| PFHxS | 82,000 | 31,000 | 480 | 4,000 | 4,100 | 490 | 1,100 | 550 |
| PFOA | 240,000 | 110,000 | 2,000 | 18,000 | 9,100 | 1,600 | 3,600 | 1,700 |
| TOTAL | 937,230 | 319,630 | 5,074 | 55,499 | 32,933 | 7,624 | 15,260 | 8,883 |

TABLE 14
Inventive Example 5 Analyte Percentage Reduction Over Time

| | | | | | | | 48 Hr | 48 Hr |
|---|---|---|---|---|---|---|---|---|
| | | Biochar | | | | | no pH | w/pH |
| | | 20 min | 1 Hr | 8 Hr | 24 Hr | 36 Hr | Buffer | Buffer |
| Analyte | Control | Percent | Percent | Percent | Percent | Percent | Percent | Percent |
| (ng/L) | (0 Hr) | Change | Change | Change | Change | Change | Change | Change |
| 3:3 FTCA | 1,000 | 100.00% | 100.00% | 100.00% | 100.00% | 100.00% | 100.00% | 100.00% |
| 5:3 FTCA | 410,000 | 75.60% | 99.70% | 95.90% | 99.00% | 100.00% | 100.00% | 99.80% |
| 7:3 FTCA | 15,000 | 100.00% | 100.00% | 94.70% | 100.00% | 100.00% | 100.00% | 100.00% |
| 6:2 FTS | 24,000 | 64.60% | 100.00% | 93.80% | 95.90% | 99.60% | 99.00% | 100.00% |
| NEtFOSAA | 430 | 100.00% | 100.00% | 88.60% | 100.00% | 100.00% | 100.00% | 100.00% |
| NMeFOSAA | 1,700 | 57.10% | 100.00% | 89.40% | 100.00% | 100.00% | 100.00% | 100.00% |
| PFBS | 11,000 | 69.10% | 99.40% | 94.50% | 91.60% | 97.20% | 93.10% | 97.40% |
| PFBA | 3,000 | 40.00% | 91.30% | 80.30% | 70.00% | 63.30% | 50.00% | 43.30% |
| PFDA | 490 | 100.00% | 100.00% | 91.40% | 100.00% | 100.00% | 100.00% | 100.00% |
| PFDS | | | | | | | | |
| PFHpS | 1,100 | 61.80% | 100.00% | 95.10% | 96.90% | 100.00% | 100.00% | 100.00% |
| PFHpA | 54,000 | 57.40% | 100.00% | 92.60% | 90.60% | 98.10% | 95.90% | 98.70% |
| PFHxA | 52,000 | 57.70% | 98.80% | 90.20% | 88.70% | 95.60% | 91.20% | 96.00% |
| PFNA | 3,900 | 59.00% | 100.00% | 91.80% | 97.50% | 100.00% | 99.20% | 100.00% |
| FOSA | 610 | 100.00% | 100.00% | 88.40% | 100.00% | 100.00% | 100.00% | 100.00% |
| PFOS | 32,000 | 53.10% | 99.30% | 92.20% | 97.60% | 99.70% | 99.50% | 99.40% |
| PFPeS | 2,100 | 58.10% | 100.00% | 93.80% | 91.40% | 98.40% | 96.20% | 98.40% |
| PFPeA | 2,900 | 55.20% | 96.90% | 81.40% | 73.80% | 79.30% | 66.60% | 76.60% |
| PFHxS | 82,000 | 62.20% | 99.40% | 95.10% | 95.00% | 99.40% | 98.70% | 99.30% |
| PFOA | 240,000 | 54.20% | 99.20% | 92.50% | 96.20% | 99.30% | 98.50% | 99.30% |
| TOTAL | 937,230 | 65.90% | 99.50% | 94.10% | 96.50% | 99.20% | 98.40% | 99.10% |

TABLE 15
Inventive Example 5 Test Conditions & Parameters

| | | After 20 | | | | | | |
|---|---|---|---|---|---|---|---|---|
| | Control | minBAM | | 1 hour | | | 8 hour | |
| | Sample | Sample | | Sample | | | Sample | |
| | Time: 10:00 | Time: 10:20 | Time: 10:51 | Time: 11:27 | Time: 1:27 | Time: 3:27 | Time: 6:27 | Time: 8:00 |
| | AMon Feb. | AMon Feb. | AMon Feb. | AMon Feb. | PMon Feb. | PMon Feb. | PMon Feb. | AMon Feb. |
| | 26, 2024 | 26, 2024 | 26, 2024 | 26, 2024 | 26, 2024 | 26, 2024 | 26, 2024 | 27, 2024 |
| pH | 7.12 | — | — | — | — | — | 6.46 | 3.69 |
| ORP | 47.1 | 57.5 | 61.2 | 61.5 | 60.9 | 218.3 | 782.1 | 911.7 |
| DO(%) | 1.2 | 18 | 46.6 | 42.8 | 84 | 70.1 | 69.6 | 52.1 |
| DO(ppm) | 0.1 | 1.48 | 3.66 | 3.46 | 7.19 | 6.27 | 6.38 | 3.8 |
| Conductivity(mScm) | 22.78 | 22.57 | 21.15 | 20.79 | 21.07 | 20.84 | 20.18 | 19.13 |
| Ab. Conductivity (mS/cm^{A}) | 20.72 | 20.09 | 19.78 | 18.73 | 17.7 | 16.47 | 15.03 | 18.92 |
| Resistivity (Ω cm) | 44 | 44 | 47 | 48 | 47 | 48 | 50 | 52 |
| Salinity (PSU) | 13.8 | 13.68 | 12.82 | 12.5 | 12.67 | 12.57 | 12.05 | 11.9 |
| Temperature (° C.) | 20.23 | 19.2 | 20.96 | 19.84 | 16.58 | 13.9 | 13.78 | 23.75 |
| Voltage | — | — | 5.7 | 5.7 | 5.7 | 5.7 | 5.7 | 5.9 |
| Amperage | — | — | 14.4 | 14.4 | 14.4 | 14.4 | 14.4 | 10.18 |

| | 24 hour | 36 hour | | | 48 hour | CaCO₂ | CaCO₂ |
|---|---|---|---|---|---|---|---|
| | Sample | Sample | | | Sample | Sample | Sample |
| | Time: 10:27 | Time: 10:27 | Time: 8:30 | Time: 9:10 | Time: 10:27 | Time: 11:24 | Time: 12:30 |
| | AMon Feb. | PMon Feb. | AMon Feb. | AMon Feb. | AMon Feb. | AMon Feb. | PMon Feb. |
| | 27, 2024 | 27, 2024 | 28, 2024 | 28, 2024 | 28, 2024 | 28, 2024 | 28, 2024 |
| pH | 5.05 | 2.97 | 2.5 | 3.02 | 3.06 | 7.07 | 7.08 |
| ORP | 746.7 | 97.2 | 809 | 85.4 | 96.8 | 68.8 | 53.2 |
| DO(%) | 68.2 | 63.6 | 119.5 | 72.6 | 115.4 | 333.9 | 295 |
| DO(ppm) | 5.74 | 5.28 | 8.45 | 5.52 | 9.22 | 26.37 | 22.36 |
| Conductivity(mScm) | 19.51 | 19.38 | 18.99 | 17.93 | 18.19 | 17.65 | 18.48 |
| Ab. Conductivity (mS/cm^{A}) | 16.76 | 16.63 | 19.25 | 17.62 | 16.89 | 16.7 | 18.24 |
| Resistivity (Ω cm) | 51 | 52 | 53 | 56 | 55 | 57 | 54 |
| Salinity (PSU) | 11.65 | 1.57 | 11.19 | 10.62 | 10.74 | 10.44 | 10.93 |
| Temperature (° C.) | 17.54 | 17.56 | 27.83 | 23.93 | 21.3 | 22.17 | 24.32 |
| Voltage | 8.8 | 8.8 | 10.1 | 8.8 | 9.8 | — | — |
| Amperage | 24 | 25 | 26.5 | 21.8 | 23.5 | — | — |

In an alternative embodiment of the present invention, as shown in FIG. 2, a system 200 is provided for the PFAS and/or PCE treatment of contaminated soil, substantially similar to that described above. System 200 includes an electrolysis chamber 202 having at least two electrodes supplied with an electrical current submerged in a cauldron 204 containing PFAS and/or PCE impacted water, and a pump 206 configured to recirculate the PFAS and/or PCE impacted water through the electrolysis chamber 202 via conduit 208. System 200 further includes a soil chamber 210 for receiving and retaining PFAS and/or PCE impacted soil 212, in line with the conduit 208, such that the soil contaminant is transferred to the water, which is then recirculated through the system 200. A volume of treatment media, including but not limited to biochar, GAC, resin and combinations thereof are also introduced into the soil and/or water of system 200. As a result, the oxidized water may desorb the contaminant from the soil into the water where it can be treated in the electrolysis chamber 202. Electrolysis current could also be directly applied to the soil simultaneously. Alternatively, the cauldron 204 may be any alternative form of a liquid retaining vessel for ex situ applications, or a lagoon, pond or other water retention structure for in situ applications.

It should be understood that the invention is not limited in its application to the details of construction and arrangements of the components and method steps set forth herein. The invention is capable of other embodiments and of being practiced or carried out in various ways by those skilled in the art. Variations and modifications of the foregoing are within the scope of the present invention. It is also understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention.

We claim:

1. A method of contamination remediation comprising the steps of:
forming recirculating electrolysis remediation system comprising
a vessel configured to receive a volume of contaminated fluid and/or soil containing an initial concentration of a perfluoroalkyl and/or polyfluoroalkyl substances (PFAS) and/or a perchloroethylene (PCE) contaminant.
the vessel having an outlet in fluid communication with an inlet or an electrolysis chamber,
the electrolysis chamber including electrodes therein, having an outlet in fluid communication with an inlet of the vessel, and
a pump configured to recirculate the contaminated fluid and/or soil between the vessel and the electrolysis chamber;
introducing a treatment media comprising biochar to the vessel;
activating the pump and electrodes;
concentrating the contaminant at the surface of the biochar to generate a final concentration of the contaminant in the fluid and/or soil that is less than the initial concentration.

2. The method of claim 1, wherein activation of the electrodes increasing an oxygen level in the recirculating electrolysis remediation system from water in contact with active electrodes.

3. The method of claim 1, further comprising a volume of sodium chloride in the treatment media, wherein activation of the electrodes results in an increase in ClO2 and/or H2O2 concentration in the fluid and/or soil.

4. The method of claim 1, wherein the PFAS is selected from a group consisting of Perfluorooctane sulfonic acid (PFOS), Perfluoroheptanesulfonic acid (PFHpS), Perfluorohexanesulphonic acid (PHHxS), Perfluoropentane sulfonic acid (PFPeS), Perfluorobutane sulfonate (PFBS), Perfluorooctanoic acid (PFOA), Perfluorohexanoic acid (PFHxA), perfluoropentanoic acid (PFPeA), and Perfluorobutanoic acid (PFBA), and combinations thereof.

5. The method of claim 1, wherein the biochar is formed of a plurality of particles having a net surface area of greater than or equal to 900 square meters per gram and less than or equal to 1,500 square meters per gram and wherein the particles have a particle size of between 0.5 microns and 4000 microns.

6. The method of claim 1, wherein the treatment media is a dilution comprising between 5% and 25.0% biochar suspended in a fluid carrier based on the total volume of the media.

7. The method of claim 1, wherein the final concentration of the contaminant is less than 5% of the initial concentration.

8. The method of claim 5, wherein the final concentration of the contaminant is less than 3% of the initial concentration.

9. The method of claim 5, wherein the final concentration of the contaminant is less than 1% of the initial concentration.

10. The method of claim 1, wherein the vessel is an in situ treatment zone.

11. The method of claim 6, wherein the media further comprises an aerobic contaminant degrading bacteria additive selected from a group consisting of Pseudomonas, Rhodococcus, Pseudonocardia, Bacillus, Actinomycetota, and combinations thereof.

12. The method of claim 6, wherein the remediation media further comprises an additional material selected from the group of a zero valent metal, an oxidation chemistry, a reductive chemistry, and a biological inoculation.

13. A recirculating electrolysis remediation system for use in the remediation of an organic contaminant comprising:
a vessel configured to receive a volume of contaminated fluid and/or soil containing an initial concentration of a perfluoroalkyl and/or polyfluoroalkyl substances (PFAS) and/or a perchloroethylene (PCE) contaminant,
the vessel having an outlet in fluid communication with an inlet or an electrolysis chamber,
the electrolysis chamber including electrodes therein, having an outlet in fluid communication with an inlet of the vessel, and
a pump configured to recirculate the contaminated fluid and/or soil between the vessel and the electrolysis chamber;
a treatment media disposed in the system including a biochar formed of a plurality of particles having a net surface area of greater than or equal to 900 square meters per gram and less than or equal to 1,500 square meters per gram, wherein the particles have a particle size of between 0.5 microns and 4000 microns,
wherein the activation of the pump and electrodes are configured to degrade an initial concentration of a perfluoroalkyl and/or polyfluoroalkyl substances (PFAS) and/or a perchloroethylene (PCE) contaminant in the treatment zone to a final concentration that is less than 5% of the initial concentration.

14. The system of claim 13, wherein activation of the electrodes increasing an oxygen level in the recirculating electrolysis remediation system from water in contact with active electrodes.

15. The system of claim 13, further comprising a volume of sodium chloride in the treatment media, wherein activation of the electrodes results in an increase in ClO2 and/or H2O2 concentration in the fluid and/or soil.

16. The system of claim 13, wherein the PFAS is selected from a group consisting of Perfluorooctane sulfonic acid (PFOS), Perfluoroheptanesulfonic acid (PFHpS), Perfluorohexanesulphonic acid (PHHxS), Perfluoropentane sulfonic acid (PFPeS), Perfluorobutane sulfonate (PFBS), Perfluorooctanoic acid (PFOA), Perfluorohexanoic acid (PFHxA), perfluoropentanoic acid (PFPeA), and Perfluorobutanoic acid (PFBA), and combinations thereof.

17. The system of claim 13, wherein the treatment media is a dilution comprising between 5% and 25.0% biochar suspended in a fluid carrier based on the total volume of the media.

18. The system of claim 13, wherein the media further comprises an aerobic contaminant degrading bacteria additive selected from a group consisting of Pseudomonas, Rhodococcus, Pseudonocardia, Bacillus, Actinomycetota, and combinations thereof.
